(19) United States
(12) Patent Application Publication
(10) Pub. No.: US 2025/0100474 A1
(43) Pub. Date: Mar. 27, 2025

(54) ROUTING STRUCTURE

(71) Applicant: YAZAKI CORPORATION, Tokyo (JP)

(72) Inventor: Kosuke Tomosada, Makinohara-shi (JP)

(21) Appl. No.: 18/893,902

(22) Filed: Sep. 23, 2024

(30) Foreign Application Priority Data
Sep. 26, 2023 (JP) 2023-163177

(51) Int. Cl. B60R 16/02; B60J 7/043; B60R 16/03

(52) U.S. Cl. CPC B60R 16/0215; B60R 16/03; B60J 7/043

(57) ABSTRACT

A routing structure includes: a first fixed portion that is fixed to a vehicle body of a vehicle; a second fixed portion that is fixed to a sliding body that moves in a vehicle front-rear direction with respect to an opening provided in a roof of the vehicle body; an exterior member that has a first end portion held by the first fixed portion and a second end portion held by the second fixed portion; an electric wire that is inserted into the exterior member; and a biasing member that is inserted into the exterior member and forms a curved portion curved in the vehicle front-rear direction between the first end portion and the second end portion of the exterior member, in which the biasing member includes a rod-shaped first member and a plate-shaped second member that supports the electric wire and the first member.

### CROSS-REFERENCE TO RELATED APPLICATION(S)

The present application claims priority to and incorporates by reference the entire contents of Japanese Patent Application No. 2023-163177 filed in Japan on Sep. 26, 2023.

### BACKGROUND OF THE INVENTION

### 1. Field of the Invention

The present invention relates to a routing structure.

### 2. Description of the Related Art

Hitherto, there has been a power feeding device for a sliding body. Japanese Patent Application Laid-open No. 2011-151906 A discloses a power feeding device for a sliding body, the power feeding device including a wire harness routed over a vehicle body and the sliding body that is slidably provided in the vehicle body and opens and closes an opening formed in the vehicle body.

The inventors of the present application have considered arrangement of a rigid biasing member inside an exterior member in a case where a routing structure between a vehicle body and a sliding body includes the exterior member. Here, it is preferable to reduce the rigidity of the biasing member from the viewpoint of securing durability against bending of the biasing member. On the other hand, in a case where curved portions are formed in the exterior member and the biasing member, when the rigidity of the biasing member is low, the curved portion is likely to have a narrowing shape. When the curved portion has a narrowing shape, a bending radius of an electric wire is decreased.

### SUMMARY OF THE INVENTION

An object of the present invention is to provide a routing structure capable of suppressing a biasing member from having a narrowing shape.

In order to achieve the above mentioned object, a routing structure according to one aspect of the present invention includes a first fixed portion that is fixed to a vehicle body of a vehicle; a second fixed portion that is fixed to a sliding body that moves in a vehicle front-rear direction with respect to an opening provided in a roof of the vehicle body; an exterior member that has a first end portion held by the first fixed portion, and a second end portion held by the second fixed portion; an electric wire that is inserted into the exterior member; and a biasing member that is inserted into the exterior member, and forms a curved portion curved in the vehicle front-rear direction between the first end portion and the second end portion of the exterior member, wherein the biasing member includes a rod-shaped first member and a plate-shaped second member that supports the electric wire and the first member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a cross-sectional view of the routing structure according to the embodiment;

FIG. 4 is a side view of the routing structure according to the embodiment;

FIG. 5 is a view for describing a narrowing shape; and

FIG. 6 is a side view of the routing structure according to the embodiment.

### DETAILED DESCRIPTION OF THE PREFERRED EMBODIMENTS

Hereinafter, a routing structure according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### EMBODIMENT

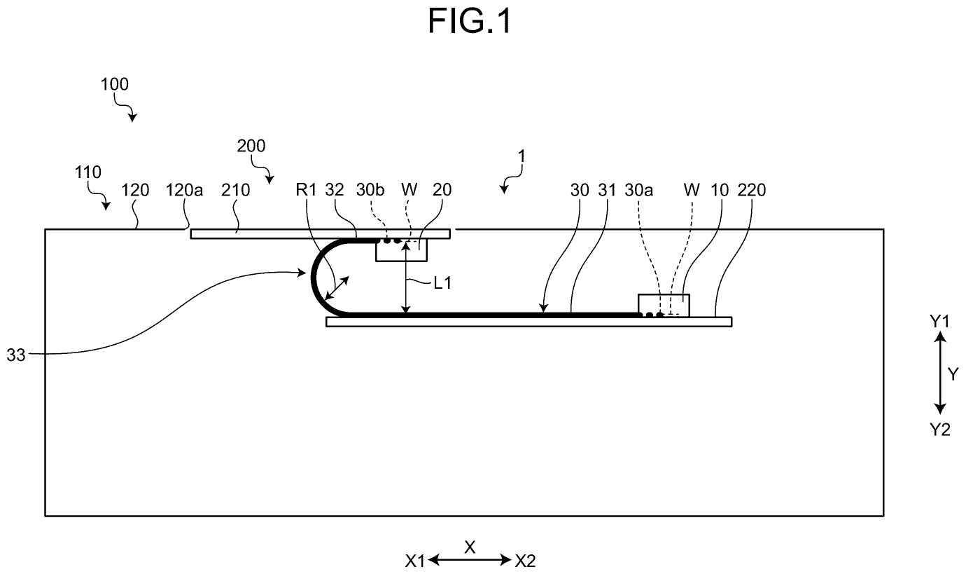

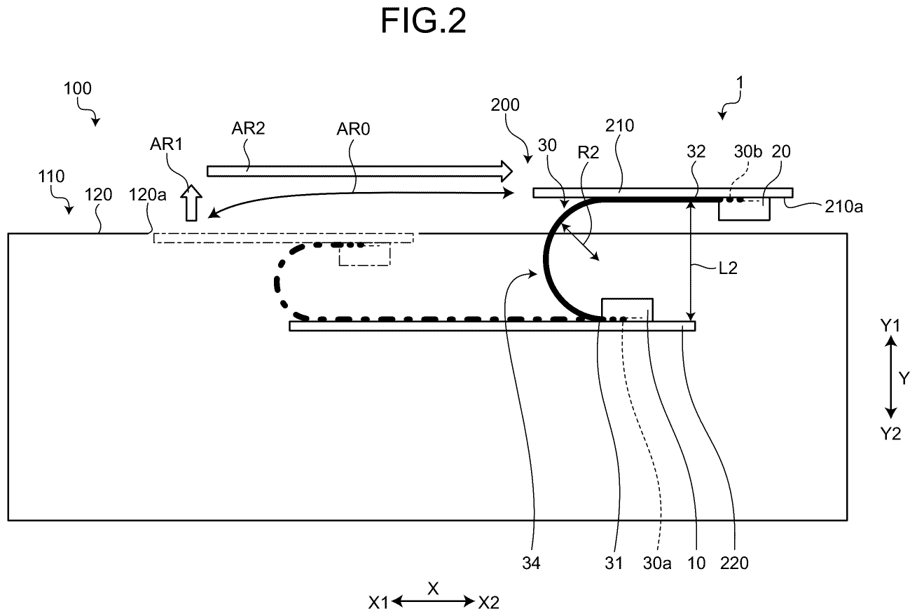

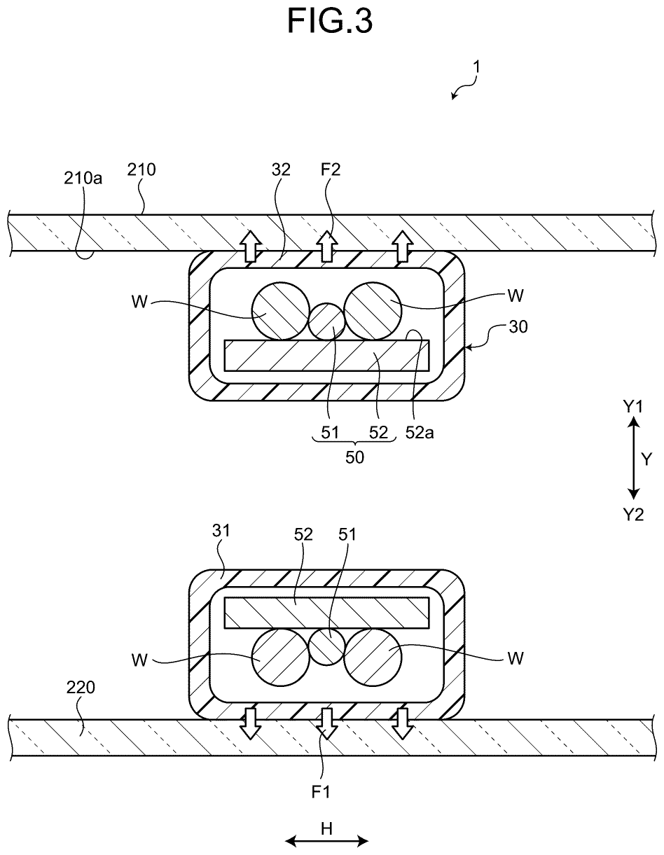

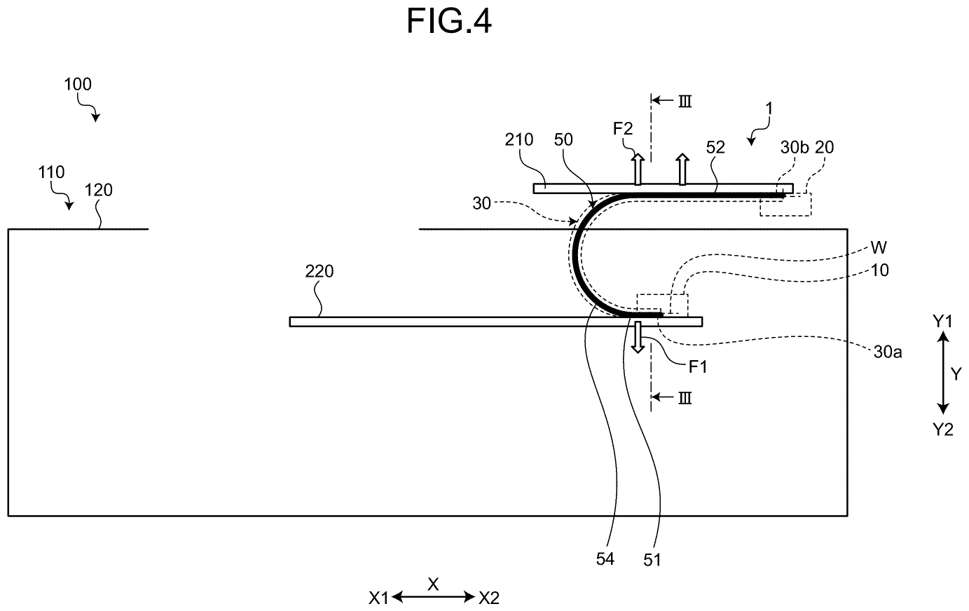

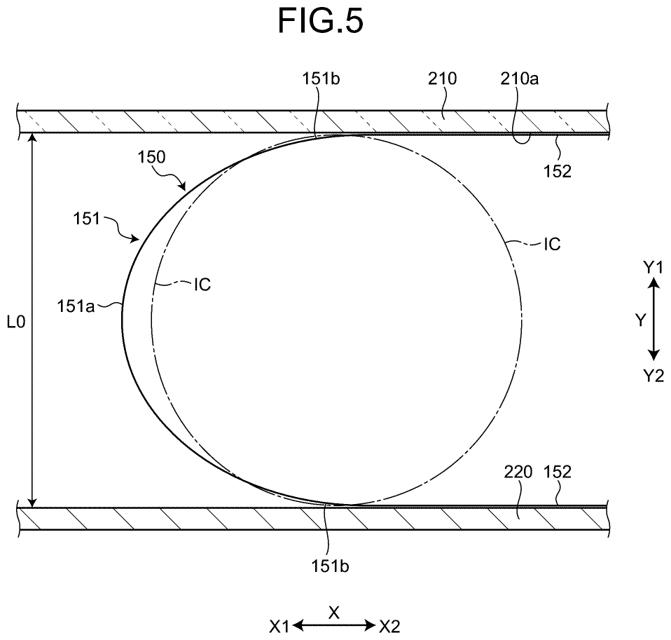

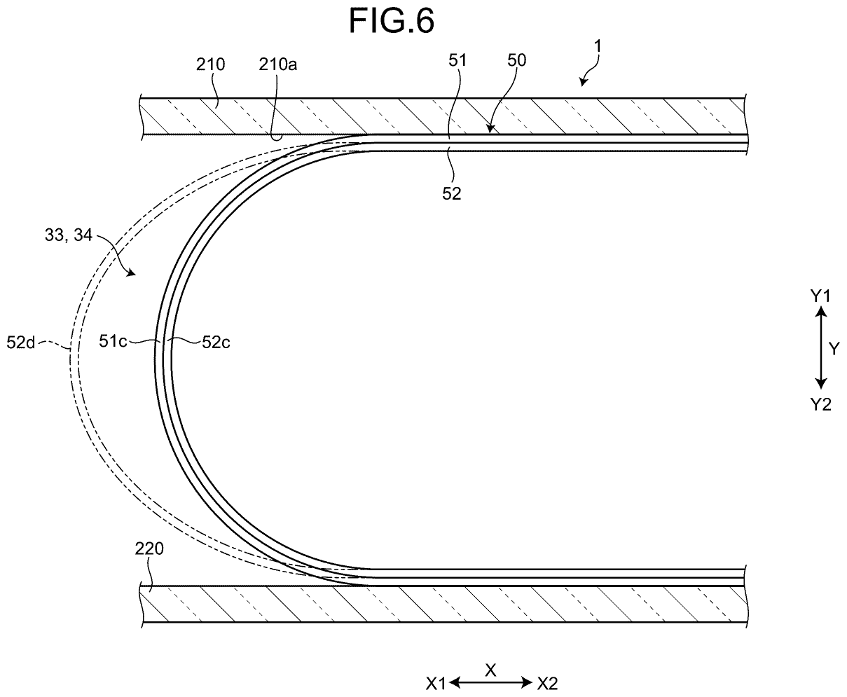

An embodiment will be described with reference to FIGS. 1 to 6. The present embodiment relates to a routing structure. FIGS. 1 and 2 are side views of the routing structure according to the embodiment, FIG. 3 is a cross-sectional view of the routing structure according to the embodiment, FIG. 4 is a side view of the routing structure according to the embodiment, FIG. 5 is a view for describing a narrowing shape, and FIG. 6 is a side view of the routing structure according to the embodiment. FIG. 3 illustrates a cross section taken along line III-III of FIG. 4.

As illustrated in FIG. 1, a routing structure 1 of the embodiment is applied to a sunroof 200 of a vehicle 100. The vehicle 100 is, for example, an automobile on which a power source such as a motor or an engine is mounted. The vehicle 100 includes a vehicle body 110. The vehicle body 110 includes a roof 120 that covers a vehicle interior. The roof 120 has an opening 120a that is opened upward.

The vehicle 100 includes a sunroof 200 that opens and closes the opening 120a. The sunroof 200 includes a sliding body 210, a rail 220, and the routing structure 1. The sliding body 210 is a member that slides in a vehicle front-rear direction X with respect to the opening 120a. The sliding body 210 of the present embodiment is a plate-shaped member that closes the opening 120a or opens the opening 120a. The sliding body 210 may be glass that can transmit light.

The sunroof 200 includes a mechanism such as a link mechanism that moves the sliding body 210 along a predetermined path, and a drive source such as a motor that operates the mechanism. The sunroof 200 moves the sliding body 210 between a fully closed position where the opening 120a is closed and a fully open position where the opening 120a is opened. FIG. 1 illustrates the sliding body 210 at the fully closed position. FIG. 2 illustrates the sliding body 210 at the fully open position.

The rail 220 is fixed to the vehicle body 110. The rail 220 extends in the vehicle front-rear direction X. The rail 220 supports the mechanism that moves the sliding body 210, and guides the mechanism in the vehicle front-rear direction X. The rail 220 further supports an exterior member 30 to form a first extending portion 31 in the exterior member 30.

The sunroof 200 of the present embodiment moves the sliding body 210 along a path AR0 illustrated in FIG. 2. The movement of the sliding body 210 along the path AR0 includes movement in the vehicle front-rear direction X and movement in a vehicle up-down direction Y. When the sliding body 210 moves from the fully closed position to the fully open position, the sliding body 210 moves toward an upper side Y1 in the vehicle up-down direction Y as indicated by an arrow AR1 in FIG. 2 and moves toward a rear side X2 in the vehicle front-rear direction X.

Conversely, when the sliding body 210 moves from the fully open position to the fully closed position, the sliding body 210 moves toward a front side X1 in the vehicle front-rear direction X and moves toward a lower side Y2 in the vehicle up-down direction Y.

As illustrated in FIGS. 1 to 3, the routing structure 1 includes a first fixed portion 10, a second fixed portion 20, an exterior member 30, an electric wire W, and a biasing member 50. The exterior member 30 and the electric wire W form a wire harness routed between the vehicle body 110 and the sliding body 210.

The first fixed portion 10 is a member fixed to the vehicle body 110 of the vehicle 100. The first fixed portion 10 may be a protector that protects the electric wire W. The first fixed portion 10 is molded using, for example, an insulating synthetic resin. The first fixed portion 10 has a space in which the electric wire W is routed and includes a holding structure for holding the exterior member 30.

The second fixed portion 20 is a member fixed to the sliding body 210 of the sunroof 200. The second fixed portion 20 may be a protector that protects the electric wire W. The second fixed portion 20 is molded using, for example, an insulating synthetic resin. The second fixed portion 20 has a space in which the electric wire W is routed and includes a holding structure for holding the exterior member 30.

The exterior member 30 is an elastically deformable tubular member. The exterior member 30 is, for example, a member called a corrugated tube. The exterior member 30 is molded using, for example, an insulating synthetic resin. The exterior member 30 may have a bellows shape.

The exterior member 30 has a first end portion 30a held by the first fixed portion 10 and a second end portion 30b held by the second fixed portion 20. The first fixed portion 10 holds the first end portion 30a such that the exterior member 30 extends from the first fixed portion 10 along the rail 220 in the vehicle front-rear direction X. The first fixed portion 10 of the present embodiment holds the first end portion 30a such that the exterior member 30 extends from the first fixed portion 10 toward the front side X1.

The second fixed portion 20 holds the second end portion 30b such that the exterior member 30 extends from the second fixed portion 20 along the sliding body 210 in the vehicle front-rear direction X. The second fixed portion 20 of the present embodiment holds the second end portion 30b such that the exterior member 30 extends from the second fixed portion 20 toward the front side X1.

The electric wire W and the biasing member 50 are inserted into the exterior member 30. The electric wire W is, for example, a sheathed electric wire including a stranded wire and a sheath. The electric wire W may be a flat routing member, a printed circuit body, or another circuit body. The electric wire W led out from the first end portion 30a is connected to a power supply or a control device arranged in the vehicle body 110. The electric wire W led out from the second end portion 30b is connected to a load arranged on the sliding body 210. The load arranged on the sliding body 210 may be, for example, a lighting device, a light control film arranged on the glass of the sliding body 210, or another electric load.

As illustrated in FIGS. 1 and 2, the exterior member 30 has curved portions 33 and 34 that are curved in the vehicle front-rear direction X between the first end portion 30a and the second end portion 30b. The curved portions 33 and 34 are formed by the biasing member 50. The curved portion 33 illustrated in FIG. 1 is a curved portion formed in the exterior member 30 in a state in which the sliding body 210 is at the fully closed position. The curved portion 33 has a radius R1. The curved portion 34 illustrated in FIG. 2 is a curved portion formed in the exterior member 30 in a state in which the sliding body 210 is at the fully open position. The curved portion 34 has a radius R2. The electric wire W in which the curved portions 33 and 34 are formed has a U shape or a J shape.

As illustrated in FIG. 1, when the sliding body 210 is at the fully closed position, a distance between the second end portion 30b and the first end portion 30a in the vehicle up-down direction Y is a first distance L1. The radius R1 of the curved portion 33 is half the first distance L1.

As illustrated in FIG. 2, when the sliding body 210 is at the fully open position, a distance between the second end portion 30b and the first end portion 30a in the vehicle up-down direction Y is a second distance L2. The radius R2 of the curved portion 34 is half the second distance L2.

In the sunroof 200 of the present embodiment, the second distance L2 at the fully open position is larger than the first distance L1 at the fully closed position. Accordingly, the radius R1 of the curved portion 33 when the sliding body 210 is at the fully closed position is smaller than the radius R2 of the curved portion 34 when the sliding body 210 is at the fully open position. The radius R1 when the sliding body 210 is at the fully closed position is smaller than a radius of a curved shape formed in the biasing member 50 when the sliding body 210 is at another position. In other words, the radius of the curved shape formed in the biasing member 50 is minimized when the sliding body 210 is at the fully closed position.

The second end portion 30b of the exterior member 30 moves together with the sliding body 210. At this time, the exterior member 30 follows movement of the second fixed portion 20 while gradually changing a position where the curved shape is formed.

The biasing member 50 of the present embodiment is a member that presses the exterior member 30 toward the sliding body 210. As illustrated in FIGS. 1 and 2, the biasing member 50 forms curved portions 33 and 34 curved in the vehicle front-rear direction X between the first end portion 30a and the second end portion 30b of the exterior member 30.

As illustrated in FIG. 3, a cross-sectional shape of the exterior member 30 of the present embodiment is rectangular. The biasing member 50 includes a rod-shaped first member 51 and a plate-shaped second member 52. The first member 51 and the second member 52 are elastically deformable members, and are made of, for example, metal or resin.

The first member 51 is a rod-shaped member and extends along the electric wire W. The first member 51 is arranged over the entire length of the exterior member 30 from the first end portion 30a to the second end portion 30b, for example. The illustrated first member 51 is a round bar having a circular cross-sectional shape.

The second member 52 is a plate-shaped member and supports the electric wire W and the first member 51. The second member 52 is arranged over the entire length of the exterior member 30 from the first end portion 30a to the second end portion 30b, for example. The illustrated shape of the second member 52 is a flat plate shape having a rectangular cross-sectional shape. The second member 52 extends from one end to the other end in the width direction H in an internal space of the exterior member 30. The second member 52 faces each of the plurality of electric wires W and the first member 51 in the vehicle up-down direction Y. In other words, the second member 52 has a width capable of supporting the first member 51 and the plurality of electric wires W.

The second member 52 in FIG. 3 is arranged on an inner side of the first member 51 and the electric wire W. Therefore, in the curved portions 33 and 34, the second member 52 is positioned on the inner side of the first member 51 and the electric wire W in a radial direction.

As illustrated in FIG. 4, the exterior member 30, the electric wire W, and the biasing member 50 are routed in a state of being curved in a U shape or a J shape. That is, the biasing member 50 extends from the first fixed portion 10 to the second fixed portion 20 in a state of having a curved portion 54.

The biasing member 50 bent so as to have the curved portion 54 applies the pressing force F1 and the pressing force F2 to the exterior member 30. The pressing force F1 is a force in the vehicle up-down direction Y, and presses the exterior member 30 toward the rail 220. The pressing force F2 is a force in the vehicle up-down direction Y, and presses the exterior member 30 toward the sliding body 210. The pressing forces F1 and F2 are restoring forces generated in the bent biasing member 50.

The pressing forces F1 and F2 are forces including the restoring force of the first member 51 and the restoring force of the second member 52. That is, in the routing structure 1 of the present embodiment, the exterior member 30 is pressed toward the sliding body 210 and the rail 220 by a resultant force of the restoring forces of the two members 51 and 52.

The pressing force F1 forms the first extending portion 31 in the exterior member 30. The pressing force F2 forms the second extending portion 32 in the exterior member 30. As illustrated in FIG. 2 and the like, the second extending portion 32 is a portion extending along a vehicle interior side surface 210a of the sliding body 210.

The vehicle interior side surface 210a is a surface facing the lower side Y2. In a case where the vehicle interior side surface 210a is a flat surface, the second extending portion 32 is formed linearly. In a case where the vehicle interior side surface 210a has a curved shape, the second extending portion 32 has a curved shape along the vehicle interior side surface 210a.

The biasing member 50 of the present embodiment is configured to press the exterior member 30 toward the sliding body 210 when the sliding body 210 is at the fully closed position and when the sliding body 210 is at the fully open position. In other words, the biasing member 50 has rigidity that can constantly press the exterior member 30 toward the sliding body 210 and bring the exterior member 30 into contact with the sliding body 210. Therefore, the routing structure 1 of the present embodiment can stabilize the shape of the exterior member 30. The biasing member 50 can bring the exterior member 30 into contact with the sliding body 210 against an external force such as vibration generated during traveling, for example.

As described below, the routing structure 1 of the present embodiment can suppress the biasing member 50 from having the narrowing shape at the curved portion. The narrowing shape will be described with reference to FIG. 5. FIG. 5 illustrates a narrowing shape formed in a biasing member 150 of a comparative example. The biasing member 150 of the comparative example has a plate shape similar to that of the second member 52. The biasing member 150 of the comparative example does not include a bar-shaped member like the first member 51. A curved portion 151 and a linear portion 152 are formed in the biasing member 150. The linear portion 152 is a portion extending linearly and is formed along each of a sliding body 210 and a rail 220.

The curved portion 151 has a tip portion 151a and two terminal end portions 151b. The tip portion 151a is a central portion of the curved portion 151 and has a convex shape in the vehicle front-rear direction X. The terminal end portion 151b is an end portion of the curved portion 151 in the vehicle up-down direction Y, and is a portion connected to the linear portion 152. The curved portion 151 has the narrowing shape. More specifically, the shape of the curved portion 151 is a shape in which a bending radius is decreased from the terminal end portion 151b toward the tip portion 151a.

FIG. 5 illustrates a virtual circle IC. The virtual circle IC is a circle whose diameter corresponds to a distance L0 from the rail 220 to the sliding body 210 in the vehicle up-down direction Y. A bending radius of the tip portion 151a is smaller than a radius of the virtual circle IC. In the curved portion 151 having a narrowing shape, the bending radius of the tip portion 151a is smaller than a bending radius of the terminal end portion 151b. In a case where rigidity of the biasing member 150 is low, such a narrowing shape is easily formed in the curved portion 151.

As means for suppressing the formation of the narrowing shape, it is conceivable to increase a thickness of the plate-shaped biasing member 150 to increase the rigidity of the biasing member 150. Meanwhile, when the thickness of the biasing member 150 is increased, durability against bending of the biasing member 150 may be deteriorated.

In the routing structure 1 of the present embodiment, the biasing member 50 includes the rod-shaped first member 51. In a case where the rod-shaped member and the plate-shaped member have similar bending rigidity, the rod-shaped member has higher bending durability as compared with the plate-shaped member. In other words, the rod-shaped member can have higher rigidity while securing the same bending durability as compared with the plate-shaped member. Therefore, the routing structure 1 of the present embodiment can suppress the biasing member 50 from having the narrowing shape at the curved portion.

In addition, the routing structure 1 of the present embodiment includes the plate-shaped second member 52 that supports the electric wire W and the first member 51. The second member 52 can suppress positional displacement of the first member 51 and twisting between the first member 51 and the electric wire W. When the sliding body 210 moves, the first member 51 slides with respect to the exterior member 30 and the electric wire W. In addition, the first member 51 slides with respect to the exterior member 30 and the electric wire W due to vibration during traveling of the vehicle 100. When the positional deviation of the first member 51 or the twisting between the first member 51 and the electric wire W occurs due to the sliding as described above, there is a possibility that the biasing member 50 cannot generate sufficient pressing forces F1 and F2.

In the biasing member 50 of the present embodiment, the second member 52 supports the first member 51, so that a posture and shape of the first member 51 can be stabilized. In addition, since the second member 52 supports both the electric wire W and the first member 51, the twisting between the first member 51 and the electric wire W hardly occurs. Therefore, the routing structure 1 of the present embodiment can suppress variations in spring performance of the biasing member 50 and suppress the biasing member 50 from having the narrowing shape at the curved portion.

In the biasing member 50, the rigidity of the first member 51 against bending may be higher than the rigidity of the second member 52 against bending. In this case, the first member 51 can restrict the narrowing shape of the second member 52. As illustrated in FIG. 6, in the curved portions 33 and 34, the first member 51 is positioned on an outer side of the second member 52 in the radial direction.

A curved portion 51c is formed in the first member 51, and a curved portion 52c is formed in the second member 52. The first member 51 having relatively high rigidity can suppress the curved portion 52c in the second member 52 from having the narrowing shape. In FIG. 6, a curved portion 52d indicated by a line with alternating long and short dashes is a curved portion formed in the second member 52 when the first member 51 is not provided. The curved portion 52d has the narrowing shape. The first member 51 supports the second member 52 from the outside in the radial direction to suppress the narrowing shape. Since the narrowing shape of the second member 52 is suppressed, a decrease in bending radius of the electric wire W is suppressed.

As described above, the routing structure 1 of the present embodiment includes the first fixed portion 10, the second fixed portion 20, the exterior member 30, the electric wire W, and the biasing member 50. The first fixed portion 10 is fixed to the vehicle body 110 of the vehicle 100. The second fixed portion 20 is fixed to the sliding body 210. The sliding body 210 moves in the vehicle front-rear direction X with respect to the opening 120a provided in the roof 120 of the vehicle body 110. The exterior member 30 has a first end portion 30a held by the first fixed portion 10 and a second end portion 30b held by the second fixed portion 20. The electric wire W and the biasing member 50 are inserted into the exterior member 30.

The biasing member 50 forms the curved portion curved in the vehicle front-rear direction X between the first end portion 30a and the second end portion 30b of the exterior member 30. The biasing member 50 includes the rod-shaped first member 51 and the plate-shaped second member 52 that supports the electric wire W and the first member 51. The rod-shaped first member 51 has higher bending durability with respect to the same bending rigidity as compared with the plate-shaped member. Therefore, the routing structure 1 of the present embodiment can suppress the biasing member 50 from having the narrowing shape at the curved portion. The bending rigidity of the first member 51 may be higher than the bending rigidity of the second member 52. In this case, the first member 51 may be arranged on the outer side of the second member 52 in the radial direction in the curved portion. The first member 51 arranged on the outer side can suppress the second member 52 in the curved portion from having the narrowing shape.

The electric wire W and the first member 51 may be arranged on the inner side of the second member 52 in the radial direction. The exterior member 30 is not limited to a so-called corrugated tube. The exterior member 30 may be a braided tube or a member used as another exterior member.

The cross-sectional shape of the rod-shaped first member 51 is not limited to a circular shape. The cross-sectional shape of the first member 51 may be a polygon or other shapes. The biasing member 50 may include a plurality of rod-shaped first members 51.

The contents disclosed in the above embodiment can be appropriately combined and executed.

The biasing member of the routing structure according to the present embodiment includes the rod-shaped first member and the plate-shaped second member that supports the electric wire and the first member. The rod-shaped first member has higher bending durability with respect to the same bending rigidity as compared with the plate-shaped member. That is, the rod-shaped first member can have high bending rigidity while securing durability. With the routing structure of the present invention, it is possible to suppress the biasing member from having the narrowing shape.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixed portion that is fixed to a vehicle body of a vehicle;
a second fixed portion that is fixed to a sliding body that moves in a vehicle front-rear direction with respect to an opening provided in a roof of the vehicle body;
an exterior member that has a first end portion held by the first fixed portion, and a second end portion held by the second fixed portion;
an electric wire that is inserted into the exterior member; and
a biasing member that is inserted into the exterior member, and forms a curved portion curved in the vehicle front-rear direction between the first end portion and the second end portion of the exterior member, wherein
the biasing member includes a rod-shaped first member and a plate-shaped second member that supports the electric wire and the first member.

2. The routing structure according to claim 1, wherein
bending rigidity of the first member is higher than bending rigidity of the second member, and
the first member is positioned on an outer side of the second member in a radial direction in the curved portion.
